(19) United States
(12) Patent Application Publication
(10) Pub. No.: US 2019/0012342 A1
(43) Pub. Date: Jan. 10, 2019

(54) METHOD AND APPARATUS FOR CONTINUOUSLY PRODUCING ANALYTICAL REPORTS

(71) Applicant: KASPECT LABS LLC, Manhattan Beach, CA (US)

(72) Inventor: Brian Alexander Cohn, Manhattan Beach, CA (US)

(21) Appl. No.: 15/645,860

(22) Filed: Jul. 10, 2017

(51) Int. Cl. G06F 17/30

(52) U.S. Cl. CPC G06F 17/30368; G06F 17/3056; G06F 17/30377

(57) ABSTRACT

Some embodiments describe a method and apparatus for continuously generating builds of an analytical report. The method monitors, at a repository, stored data and code for changes. The method determines, at the repository, a change in the data. The method notifies a pipeline of the change in the data. The method automatically rebuilds, at the pipeline, source code based on the change to the data to produce a document having a visualization derived from the data.

### BACKGROUND

### Field

The present disclosure relates generally to a method and apparatus for generating statistical models and more specifically, for generating statistical models on a continuous basis.

### Background

Creating reports with visual representations of data are commonly used in a multitude of industries. As computers have gained processing and storage power, the ability to store and process petabytes-worth of data has become increasingly possible and increasingly useful to users. For instance, researchers continuously collect data from varied sources, and analyze the stream of data to test hypotheses across every scientific domain. In parallel, users in industry rely on reports generated from modeling large amounts of data to make predictions about manufacturing efficacy, market conditions, environmental status, stock performance, investment outlook and many more factors.

Such reports can take days to complete—even at institutions with ample funding and supercomputer access. Accurate statistical reports are a complex art to design, and require immense skill to assemble. With respect to performance, designing an effective infrastructure that can handle many parallel computations is nontrivial, even with an experienced team. Moreover, if source code or data for one of many reports scheduled to run is flawed, a user may only discover after several days that the entire data analysis job failed and have to run the entire job again from scratch. The data from which an analysis is composed could be changed, unbeknownst to the researchers or analysts forming interpretations off the resultant output. There exists no such platform that allows for a simple manner to review data as it changes over time.

Report generation is an iterative process, requiring constant shifting between text editors, research articles, web browsers, analytical programs, code, and terminal access points; a report that is well prepared has an intricate development process.

Additionally, to generate reports with different model parameters or input criteria requires a user to make such changes directly to source code, and must be re-run to generate the updated results. Typically, source code is collaboratively written by many different developers, meaning that a small change of code could interrupt an entire analytical pipeline, thereby obstructing analytics that other researchers are working on. Code that is not well documented or is unfamiliar to a developer makes it cumbersome and difficult to make the necessary changes without breaking the code. Therefore, it is exceedingly challenging for researchers to create an analytical pipeline that generates reports from data in parallel, continuously rebuilds when data or source code changes, is conducive to collaborative work, and is simple to re-run with new parameters.

### SUMMARY

Several embodiments of the present disclosure will be described more fully hereinafter with reference to various methods and apparatuses.

Some embodiments of the disclosure describe a process for continuously generating builds. The process may receive changes to parameters associated with the data such as sample size, the number of iterations, the model lambda values, and respond by generating a new visual representation of the data “on the fly.” The parameters may be changed at a command line or a web user interface.

Some data sets or analyses may be very large. As a result the present disclosure is also capable of running processes in parallel on one or more CPUs—on as little as one machine, or across many nodes of a high performance computing cluster. This enables a user to receive results for different analyses, in the form of a visual representation of the data, as soon as each becomes available. Moreover, if one analysis fails, others will not be impacted, allowing a user to fine-tune the failed analysis and re-run. As re-running the entire analysis could take several days, this method allows for faster debugging and more modular analytical research. Additionally, some features enable a user to configure the number of nodes based on different parameters and reconfigure the number of nodes as the analysis progresses. Some examples of parameters include lambda values, time windows, sample resolution, sample size, bootstrapping specifications, subsampling groups, string inputs, numerical thresholds, API endpoints, IP addresses, anonymous function definitions, and algorithmic hyperparameters.

Another optimization of the present disclosure is caching. In some embodiments of the disclosure, multiple visual representations may be generated from a same data set and function performed on the data set. The result of the data set and function may be cached in a storage so that future analyses may benefit from it by saving time in not re-running the entire analysis again.

It is understood that other aspects of methods and apparatuses will become readily apparent to those skilled in the art from the following detailed description, wherein various aspects of apparatuses and methods are shown and described by way of illustration. As understood by one of ordinary skill in the art, these aspects may be implemented in other and different forms and its several details are capable of modification in various other respects. Accordingly, the drawings and detailed description are to be regarded as illustrative in nature and not as restrictive.

### BRIEF DESCRIPTION OF THE DRAWINGS

Various aspects of processes and apparatuses will now be presented in the detailed description by way of example, and not by way of limitation, with reference to the accompanying drawings, wherein:

FIG. 1 illustrates a exemplary overview of a continuous build platform.

FIG. 2 illustrates the benefits of parallelizing the report generation of FIG. 1.

FIG. 3 illustrates an exemplary embodiment of a process for committing a new change to the continuous build platform.

FIG. 4 conceptually illustrates a process for continuously producing a new build.

FIG. 5 conceptually illustrates a process 550 for building and rebuilding a report for a scientific research project.

FIG. 6 illustrates an exemplary embodiment of a continuous build platform for setting parameters.

FIG. 7 illustrates an exemplary embodiment of a continuous build platform with a performance optimization.

FIG. 8 conceptually illustrates a process for optimizing the continuous build platform.

FIG. 9 illustrates an exemplary computer system of some embodiments of the platform.

### DETAILED DESCRIPTION

The detailed description set forth below in connection with the appended drawings is intended as a description of various exemplary embodiments of the present invention and is not intended to represent the only embodiments in which the present invention may be practiced. The detailed description includes specific details for the purpose of providing a thorough understanding of the present invention. However, it will be apparent to those skilled in the art that the present invention may be practiced without these specific details. In some instances, well-known structures and components are shown in block diagram form in order to avoid obscuring the concepts of the present invention. Acronyms and other descriptive terminology may be used merely for convenience and clarity and are not intended to limit the scope of the invention.

The word “exemplary” is used herein to mean serving as an example, instance, or illustration. Any embodiment described herein as “exemplary” is not necessarily to be construed as preferred or advantageous over other embodiments. Likewise, the term “embodiment” of an apparatus, method or article of manufacture does not require that all embodiments of the invention include the described components, structure, features, functionality, processes, advantages, benefits, or modes of operation.

It will be further understood that the terms “comprises” and/or “comprising,” when used in this specification, specify the presence of stated features, steps, operations, elements, and/or components, but do not preclude the presence or addition of one or more other features, integers, steps, operations, elements, components, and/or groups thereof. The term “and/or” includes any and all combinations of one or more of the associated listed items.

Unless otherwise defined, all terms (including technical and scientific terms) used herein have the same meaning as commonly understood by a person having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The present disclosure relates to a process for continuously building software generated reports for statistical analyses. A new report may be triggered by a change to the data associated with the report or a change to the source code that runs the report. Additionally it may be possible to easily regenerate reports with different parameters without accessing the source code. A report may be a document such as a PDF that has a visual representation of data, such as a graph or chart. However, one of ordinary skill in the art will appreciate that a document is not limited to a PDF. Any suitable electronic format such as HTML, md, rst, .doc, .tex, etc., capable of displaying images, videos, audio, tables, and/or text may be used without departing from the scope of the disclosure. Additionally, a data analysis or report may be used interchangeable referencing any process for computing and displaying some sort of statistical result. For the purposes of the present disclosure a result may be the outcome of applying at least one function (f(x)) or functional model to a data set. The terms data and data set may be used interchangeable as well.

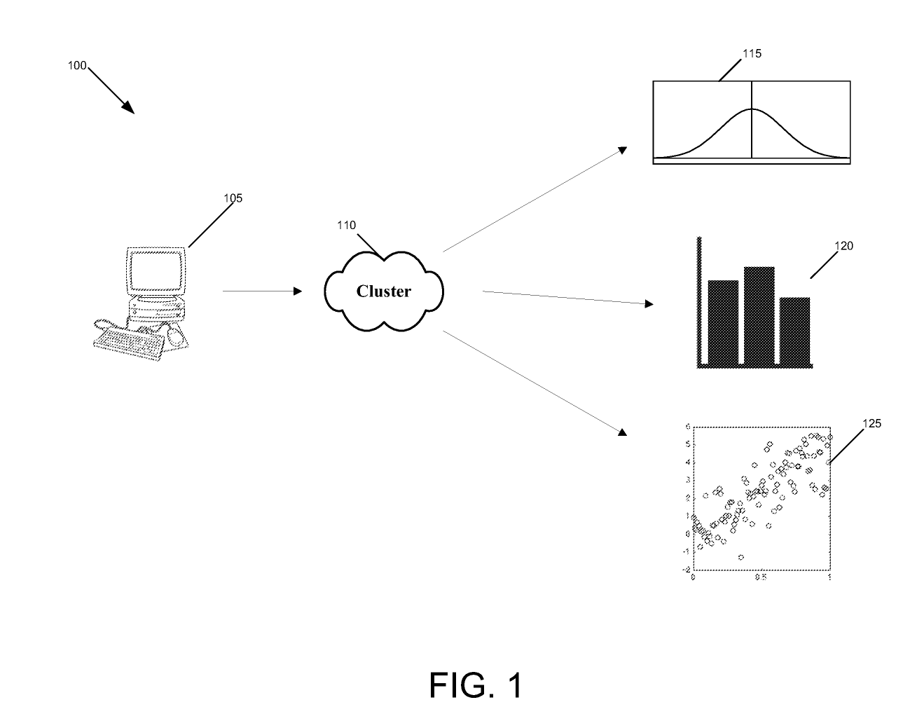

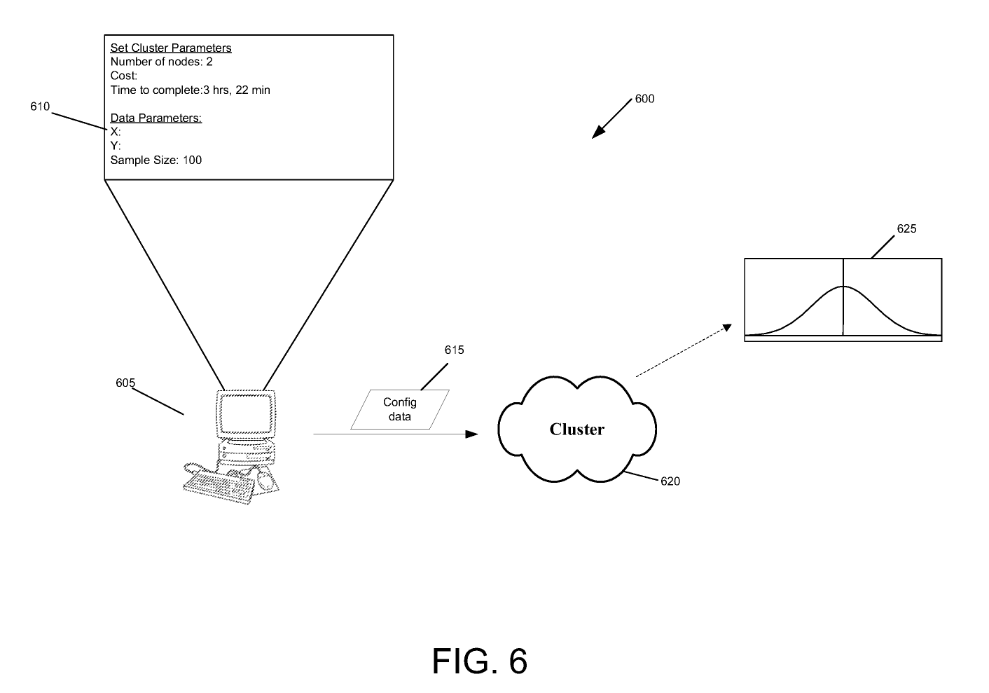

FIG. 1 illustrates a exemplary overview of a continuous build platform 100. The continuous build platform 100 includes a client 105, a cluster 110, and reports 115-125. The reports 115-125 may be visual representations of different data analyses performed at the cluster 110. The client 105 may have a web interface in which a user may specify instructions for how to generate/run the reports 115-125. For instance, the cluster 110 may receive instructions from the client 105 to run the report on a specified number of nodes on the cluster 110. Setting cluster parameters will be discussed in greater detail with respect to FIG. 6

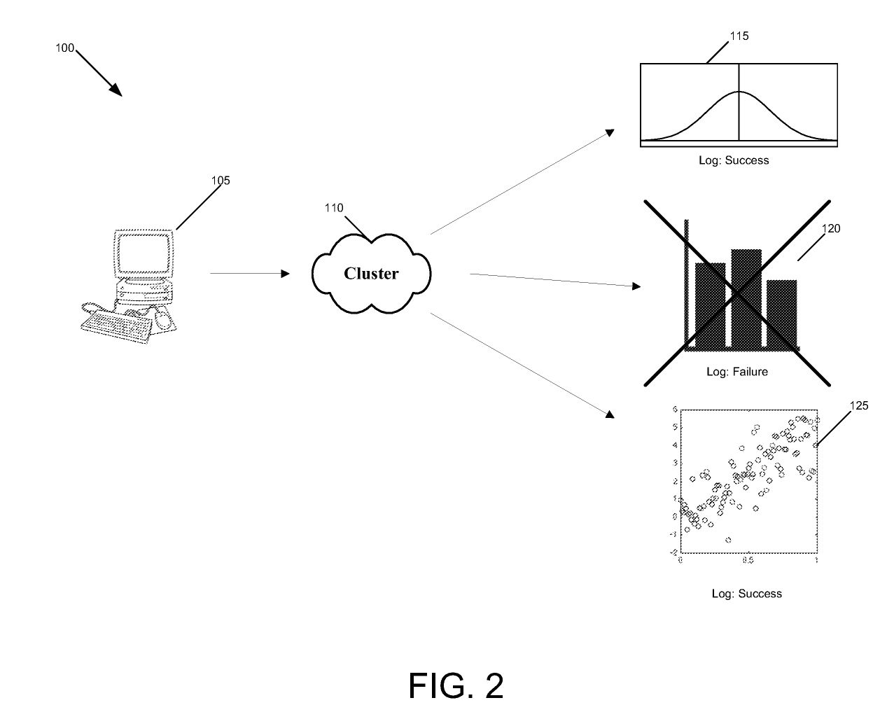

FIG. 2 illustrates the benefits of parallelizing the report generation of FIG. 1. As shown in FIG. 2, a log entry is generated for each report. In this example, 3 reports were generated using 3 different nodes of the cluster 110, in parallel. As show, report 115 succeeded, report 120 failed, and report 125 succeeded. Since the reports 115-125 were all run on different clusters, the fact that one (report 120) failed did not preclude the others (reports 115 and 125) from completing and being available to a user. Instead, the result is replaced with a code-error placeholder where the result would have appeared. This placeholder is a place where the date, time, and other parameters about the failure will appear.

Reports can fail when the processes leading to a fully-functional set of output statistics is interrupted by an error; one such example is a bug within the code that throws an error, such as a misappropriated IP address, or a piece of code that received an unexpected new data type. Parallelizing report generation means that one failure will not stop the generation process completely. Only processes running on the same node within the cluster 110 may halt if there is a failure. Those running on different nodes will not be impacted.

This is advantageous because oftentimes report generation can take hours, or even days, to run. Thus if one report fails, the successful reports modules which are unaffected by the bug will complete, and only the report(s) that failed will have re-run (or modified, then re-run); this distribution of computing responsibility across the nodes results in a significant time and cost savings. For instance, a researcher waiting for the reports generated in FIG. 2 may be able to continue his or her research based on reports 115 and 125 while report 120 is rerun.

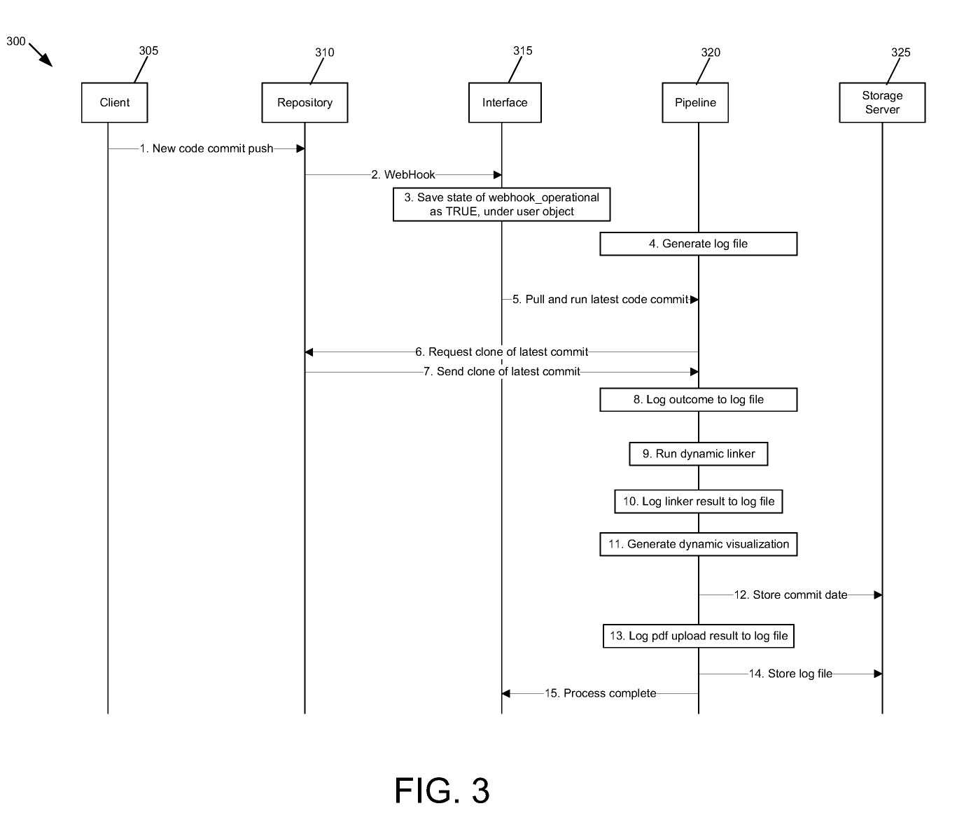

FIG. 3 illustrates an exemplary embodiment of a process 300 for committing a new change to the continuous build platform. The process 300 is performed across several different apparatuses. The apparatuses include a client 305, a repository 310, an interface 315, a pipeline 320, and a storage server 325. The client 305 may be similar to the client 105 described above. The repository 310 may be any source control application and storage such as GitHub, SVN, CVS, Mercurial or any other suitable source code repository. The interface 315 may be a web user interface and the storage server may be any suitable device or cluster of devices having storage capability such as a cloud storage environment. The pipeline 320 is responsible for processing the source code and data to generate the reports and set up clusters for processing the reports.

As shown, the client 305 transmits a push notification to the repository 310 indicated that new source code can be committed to the current software build. The repository 310 notifies the interface 315 that a new build is available. The interface 315 sets a flag to TRUE. Such a notification may present other users the opportunity to dynamically rerun the updated source code as a result of the new code commit. Once the new code is committed to the repository 310, the pipeline 320 generates a log file. The interface 310 then sends a notification to the pipeline 320 to pull and run the latest code commit. The pipeline 320 requests a copy of the latest code commit from the repository 310. In response, the repository 310 sends a copy of the latest code commit to the pipeline 320 for further processing. The pipeline 320 logs the result of the latest code commit. The result may be obtained from running the code against a data set to generate a result and a visual representation of the analysis.

The pipeline 320 may then run a dynamic linking tool to generate a pdf document that includes the visual representation and text data. The pipeline 320 then logs the outcome of the dynamic linking. The pipeline 320 may then run a tool to convert the document into a dynamic document that enables different user defined views of the visual representation. For instance, the visual representation may be a 3-dimentional cluster diagram. The diagram may be displayed and shift views in response to an interactive drag and drop interaction from a user viewing the diagram, with either a mouse, stylus, saccade, fingertip, or hand pointer input. The pipeline 320 then sends the document to be stored at the storage server 325 along with the commit date of the source code. By storing the commit date and branch information from the source code repository, the user is able to visually track changes to the entire source code tree, and investigate how those changes may impact data analyses.

The pipeline 320 logs the success or failure of uploading the document to the storage server 325. The pipeline 320 then transmits the log file to the storage server 325 so the storage server 325 can maintain the log file. The pipeline 320 then sends a notification to the interface 315 indicating that the commit process has completed. The interface 315 may notify the user whether a new document was generated successfully or if any problems occurred during the process. The process 300 may rerun continuously each time new code is committed. Additionally, the process 300 may rerun when new data is added to a dataset that the source code utilizes.

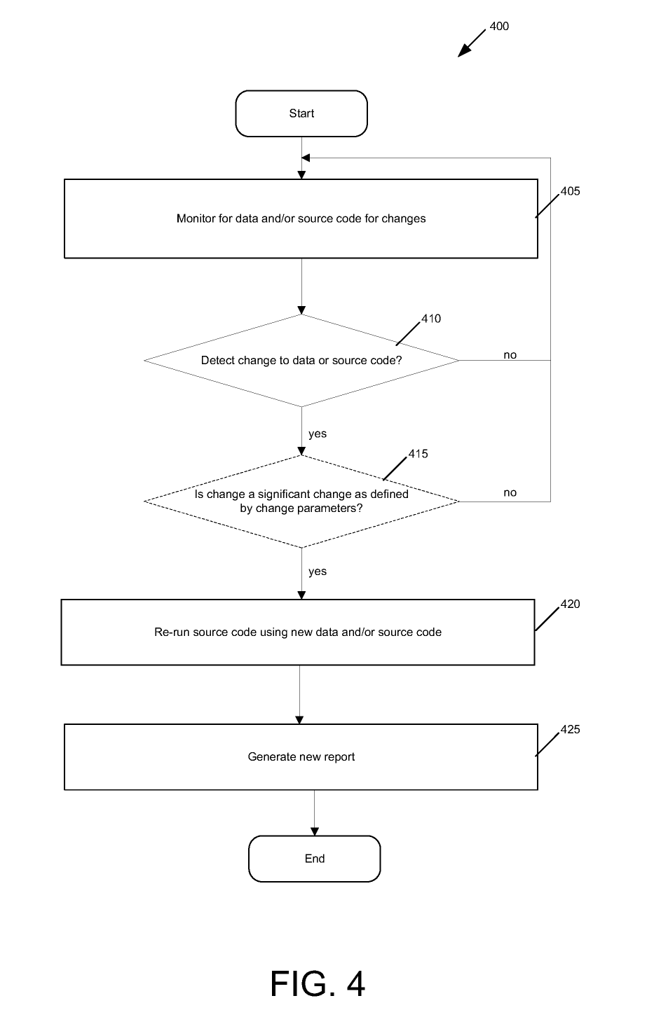

FIG. 4 conceptually illustrates a process 400 for continuously producing a new build. The process 400 may be performed by the continuous build platform 100. The process 400 may begin after an initial code base and/or dataset has been stored in the repository.

As shown, the process 400 monitors (at 405) the repository for data and/or changes to the source code. The process 400 detects (at 410) whether there has been a change to the data or source code. When the process 400 does not detect any changes, the process 400 returns to monitoring (at 405) the repository. When the process 400 determines there has been a change to the data or source code, the process 400 may optionally determine (at 415) whether the change is significant. When the process 400 determines that the change is not significant, the process 400 returns to monitoring (at 405) the repository. When the process 400 determines that the change is significant, the process 400 re-runs (at 420) the source code using the new data and/or source code. At this point, a notification may be provided to the user to indicate the change in the data. The process 400 then generates (at 425) a new report, which may be stored in server storage with a date stamp and log history.

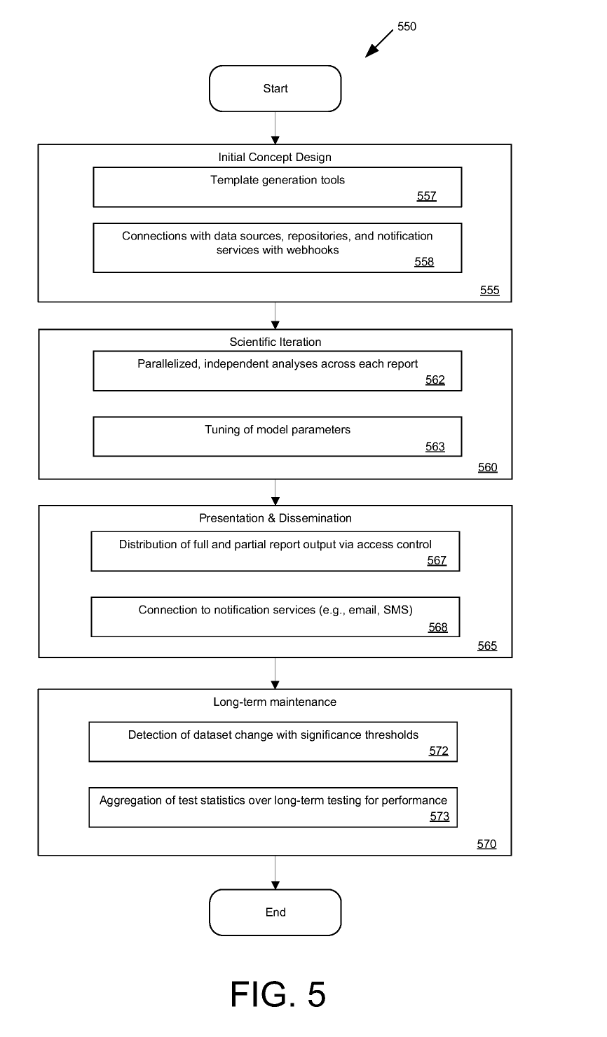

FIG. 5 conceptually illustrates a process 550 for building and rebuilding a report for a scientific research project. The process 550 may be performed by the continuous build platform 100. The process 550 may begin when the client receives user input to open an application for receiving project data to generate a report. Such applications may include a text editor or a software development environment.

As shown, the process 550 performs an initial concept design 555. The initial concept design includes the development of a research hypothesis and the design of prospective analysis. A research hypothesis may include a proposed answer to a scientific question that the prospective analysis is designed to prove or disprove. Template generation tools 557 and a connections with data sources, repositories, and notification services 558 may be provided as part of the initial concept design 555.

The template generation tools 557 may provide examples of data visualizations that assist the user in determining whether a particular visualization would adequately prove/disprove the hypothesis. For instance, if the hypothesis is based on a classification problem, the template generation tools 557 may provide a sample Support Vector Machine (SVM) plot and a confusion matrix visualization to assist in the initial concept design.

The connections 558 are provided in the initial concept design 555 so that data can be pulled from external resources for the analysis in both the initial concept design 555 and subsequent analyses performed by the process 550.

The process 550 then performs scientific iteration 560. Scientific iteration 560 may include further performing the collection of data, design of the data collection infrastructure, API connections, service connections, and the data analysis. The scientific iteration 560 may provide parallelized, independent analyses across each report 562 and the capability of tuning model parameters 563. For instance, if three reports, each including a visualization are built (e.g., boxplot, a scatterplot, and a confusion matrix), each build may be run in parallel. Additionally, the parameters, such as sample size or number of replicates, may be separately configured and reconfigured for each visualization to fine tune the report.

The process 550 then performs presentation and dissemination 565. Presentation and dissemination may include the expansion of the report and data associated with the report to a broad audience. Such dissemination may provide verification and validation of the research concepts covered by the report, as well as, help identify statistical issues early on. For example, if a computational simulation is performed, the platform 100, may provide prospective visualization, such as graphs, to an additional user. The additional user may review the visualization and associated analysis, add comments, and instigate a re-building of the data analysis associated with the visualization. This results in the capability of providing a continuous flow of new visualizations and plots to collaborators and reviewers. Such a capability enables several different users, such as other scientists to partake in the research process.

At 570, the process 550 reaches long-term maintenance. Long-term maintenance 570 enables effective sharing and accessibility of the research project to several different users. Long-term maintenance 570 includes detection of dataset change with significance threshold 572 and aggregation of test statistics over long-term testing for performance 573. When the process 550 detects a change to the dataset that is above a preset significance threshold, the research analysis is rebuilt to generate a new report. The user may then, optionally, send the new report to collaborators. Reports may be automatically sent after each new build is completed. Additionally, the visualizations and/or output reports may be viewed in a historical view. The historical view provides the history of the visualizations as the research project changes and/or is refined. The historical view may also provide the history of the visualizations that illustrates the changes to a dataset over a period of time.

FIG. 6 illustrates an exemplary embodiment of a continuous build platform 600 for setting some of the available parameters prior to computation. As shown, the platform 600 includes a client 605, an interface 610, configuration data 615, a server cluster 620, and a report 625. The client 605, cluster 620, and report 625 may be similar to the client 105, the cluster 110, and any of the reports 115-125 described with respect to FIG. 1.

As shown, the interface 610 may be displayed on the client 605. In some embodiments of the system, the interface may be a command line interface, a mobile application, a watch application, or a web application. Conversely, the interface 610 may provide a graphical interface capable of receiving input from a user. As shown, the user may input various data parameters or cluster parameters. The cluster parameters may set the number of nodes that will be used to process a data set. The user may set a cluster size and the interface 610 may provide information such as how long the process will take to complete and the cost of completing the process. Additionally, the user may provide different data parameters to be run against the data set without having to manually modify source code. For instance, the user may adjust the axis of a graph, change the sample size of the data being run, add noise to the input data, remove samples from a given dataset, or change parameters for an internal algorithm that will transform the data. Since it is not necessary to modify the source code to change these parameters, re-running reports becomes simple and efficient; as such, ad-hoc questions about the data are more quickly answered. The parameters may be transmitted as configuration data 615 over the internet or local network to the cluster 620 to run the report 625.

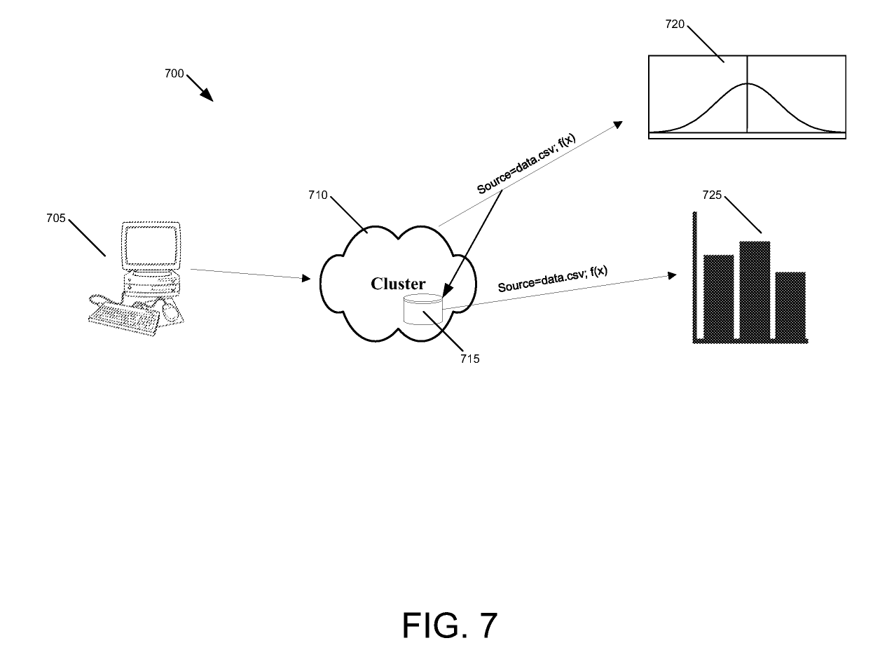

FIG. 7 illustrates an exemplary embodiment of a continuous build platform 700 with a performance optimization. As shown, the platform 700 includes a client 705, a cluster 710, a storage 715, and reports 720 and 725. The client 705, the cluster 710, and the reports 720 and 725 may be similar to the client 105, the cluster 110, and the reports 115-125 as describe with respect to FIG. 1. The storage 715 may be used to maintain results from different data analysis processes. For instance, to generate the report 720, a function, f(x), was applied on the data source, data.csv. The result of processing this data is then stored in the storage 715. A subsequent report, report 725 is then generated requiring the same result obtained from generating the report 720, and with no significant changes identified from process 500, the cluster node will pull the result obtained for 720 and reuse it to generate the report. As a result, instead of rerunning the same function on the same data multiple times, which could take several days, the cluster node will have a result more quickly. This optimization greatly reduces the cost of utilizing expensive processing resource and reduces time because a report can be generated in seconds rather than days, for large data sets.

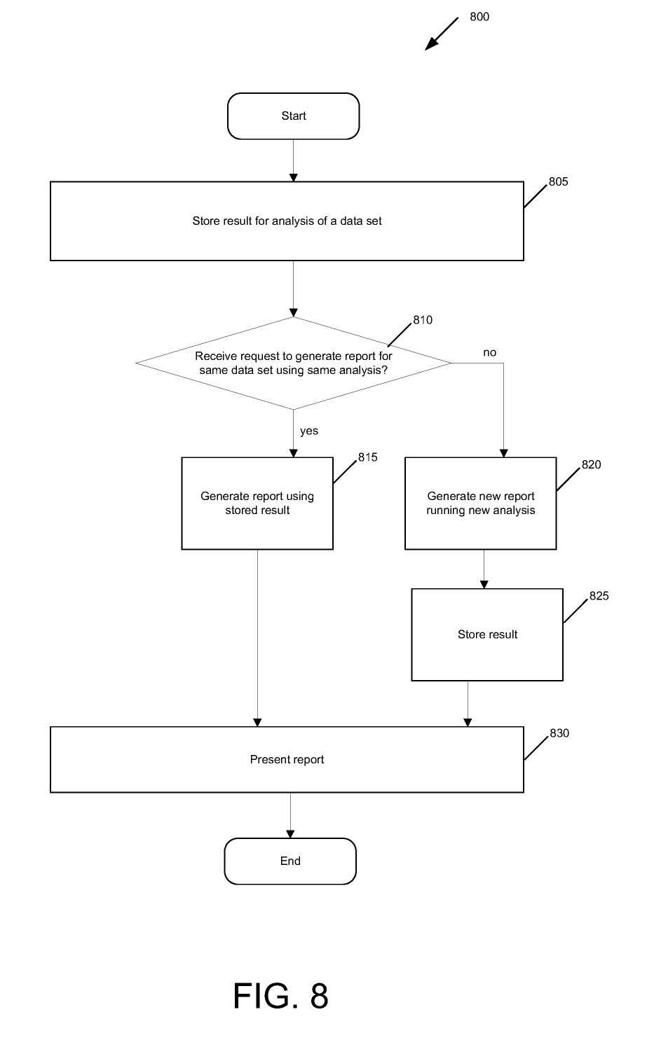

FIG. 8 conceptually illustrates a process 800 for optimizing the continuous build platform. The process 800 may be performed by a pipeline such as the pipeline 320 described with respect to FIG. 3. The process 800 may begin after at least one report generation process has been initiated.

As shown, the process 800 stores (at 805) the result for a precomputed analysis of a data set. The process determines (at 810) whether a request to generate a report for as same data set using a same analysis, or function, has been received. When the process 800 determines that such a request has been received, the process 800 generates (at 815) a report using the stored result from the previous report. The process 800 then presents (at 830) the report to an interface for display. The process 800 may also store the report at a server. When the process 800 determines such a request was not received, the process 800 generates (at 820) a new report running an entirely new analysis. The process 800 then stores (at 825) the result of the new analysis. The process 800 presents the new report to the interface for display. The process 800 may also store the report at the server.

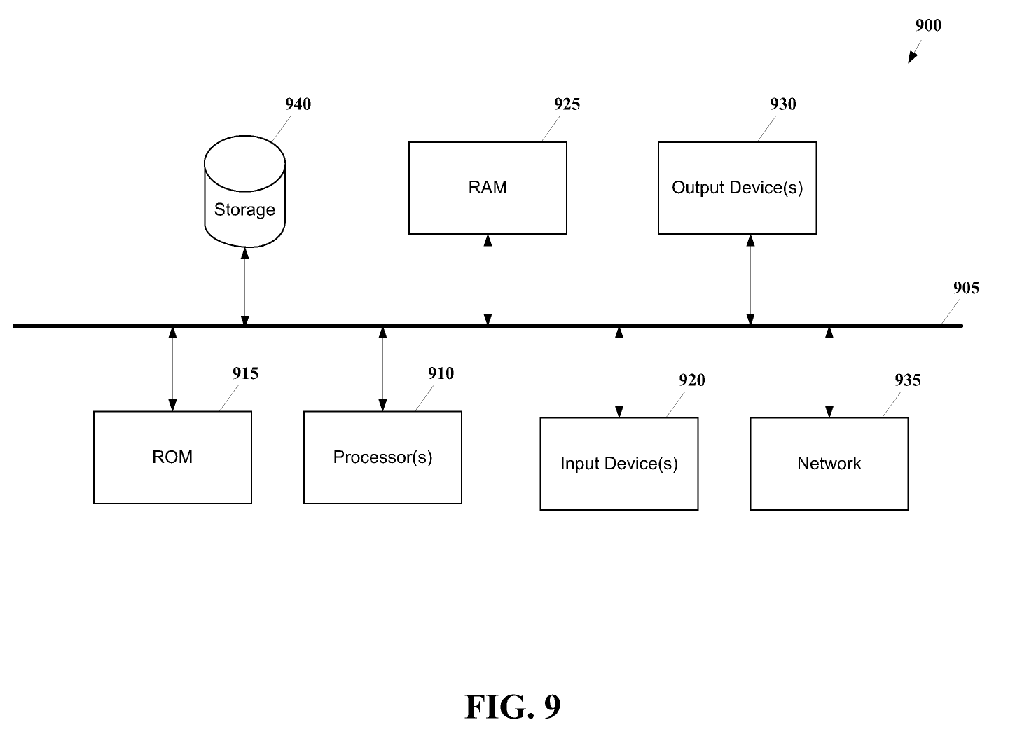

FIG. 9 illustrates an exemplary computer system 900 that may implement any of the apparatuses, nodes, or servers in the platform discussed above. The computer system includes various types of machine readable media and interfaces. The system includes a bus 905, processors 910, read only memory (ROM) 915, input device(s) 920, random access memory 925), output device(s) 930, a network component 935, and a permanent storage device 940. The computer system include a computer program product including the machine readable media.

The bus 905 the communicatively connects the internal devices and/or components of the computer system. For instance, the bus 905 communicatively connects the processor(s) 910 with the ROM 915, the RAM 925, and the permanent storage 940. The processor(s) 910 retrieve instructions from the memory units to execute processes of the invention.

The ROM 915 stores static instructions needed by the processor(s) 910 and other components of the computer system. The ROM may store the instructions necessary for the processor to execute the web server, web application, or other web services. The permanent storage 940 is a non-volatile memory that stores instructions and data when the computer system 900 is on or off. The permanent storage 940 is a read/write memory device, such as a hard disk or a flash drive. Storage media may be any available media that can be accessed by a computer. By way of example, the ROM could also be EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

The RAM 925 is a volatile read/write memory. The RAM 925 stores instructions needed by the processor(s) 910 at runtime. The bus 905 also connects input and output devices 920 and 930. The input devices enable the user to communicate information and select commands to the computer system. The input devices 920 may be a keyboard or a pointing device such as a mouse. The input devices 920 may also be a touch screen display capable of receiving touch interactions. The output device(s) 930 display images generated by the computer system. The output devices may include printers or display devices such as monitors.

The bus 905 also couples the computer system to a network 935. The computer system may be part of a local area network (LAN), a wide area network (WAN), the Internet, or an Intranet by using a network interface. The web service may be provided to the user through a web client, which receives information transmitted on the network 935.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The various aspects of this disclosure are provided to enable one of ordinary skill in the art to practice the present invention. Various modifications to exemplary embodiments presented throughout this disclosure will be readily apparent to those skilled in the art, and the concepts disclosed herein may be extended to other devices or processes. Thus, the claims are not intended to be limited to the various aspects of this disclosure, but are to be accorded the full scope consistent with the language of the claims. All structural and functional equivalents to the various components of the exemplary embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. A method for continuously generating builds, the method comprising:
monitoring, at a repository, stored data for changes;
determining, at the repository, a change in the data;
notifying a pipeline of the change in the data; and
automatically rebuilding, at the pipeline, source code based on the change to the data to produce a document having a visualization derived from the data.

2. The method of claim 1, wherein determining the change comprises determining the data has changed more than a threshold amount.

3. The method of claim 1, further comprising requesting, at the pipeline, a clone of the rebuilt software.

4. The method of claim 1, further comprising generating the document at the pipeline for display.

5. The method of claim 4 comprising:
receiving, at a user interface, a command to change a parameter associated with the visualization; and
reproducing the document based on the parameter change.

6. The method of claim 1, further comprising selecting a number of nodes on a cluster for producing the document.

7. The method of claim 6, further comprising producing multiple documents having visualizations based on different data sets or functions, wherein at least two document are processed in parallel by two different nodes on the cluster.

8. The method of claim 7, wherein one of the two documents fails and the other document is produced.

9. The method of claim 1, further comprising a result of computing the data for producing the document to be used by a future process creating a different document using the same data and parameters.

10. A system comprising:
a repository for storing and monitoring data for changes, determining a change in the data, and sending a notification of the change in data; and
a pipeline for automatically rebuilding source code based on the change to the data to produce a document having a visualization derived from the data, upon receiving a notification from the repository of the change in the data.

11. The system of claim 10, wherein the repository determines the change by determining the data has changes more than a threshold amount.

12. The system of claim 10, wherein the pipeline further requests a clone of the rebuilt software.

13. The system of claim 10, wherein the pipeline generates the document for display.

14. The system of claim 13 further comprising:
an interface for receiving a user interface command to change a parameter associated with the visualization, wherein the pipeline reproduces the document based on the parameter change.

15. The system of claim 10, wherein the interface receives input to select a number of nodes on a cluster for producing the document.

16. The system of claim 15, further comprising producing multiple documents having visualizations based on different data sets or functions, wherein at least two document are processed in parallel by two different nodes on the cluster.

17. The system of claim 16, wherein one of the two documents fails and the other document is produced.

18. The system of claim 10, further comprising a result of computing the data for producing the document to be used by a future process creating a different document using the same data and parameters.

19. A computer program product comprising a machine-readable medium comprising instructions executable to:
monitor, at a repository, stored data for changes;
determine, at the repository, a change in the data;
notify a pipeline of the change in the data; and
automatically rebuild, at the pipeline, source code based on the change to the data to produce a document having a visualization derived from the data.

20. The computer program product of claim 18, further comprising instructions executable select a number of nodes on a cluster for producing the document.
